(19) United States
(12) Patent Application Publication
(10) Pub. No.: US 2002/0188556 A1
(43) Pub. Date: Dec. 12, 2002

(54) System and method for monitoring and analyzing exposure data

(76) Inventors: James Colica, Greenwich, CT (US); Barbara Moss, New York, NY (US); Lisa Demko, Stamford, CT (US); Karen Prescott, Wilton, CT (US)

Correspondence Address: BUCKLEY, MASCHOFF, TALWALKAR, & ALLISON, 5 ELM STREET, NEW CANAAN, CT, 06840, US

(21) Appl. No.: 09/847,677

(22) Filed: May 2, 2001

(51) Int. Cl. G06F 17/60

(52) U.S. Cl. 705/38

(57) ABSTRACT

A method for monitoring financial exposure in an entity having a plurality of operating units includes gathering information about each of the operating units including product information and collateral information, and mapping the product information and the collateral information to standardized product information and standardized collateral information. Customer data is received from each of the operating units which identifies a customer of each of the operating units. Unit exposure data is also received which identifies an exposure of the operating unit to each customer. Aggregated exposure information for the entity is generated based on this information.

### FIELD OF THE INVENTION

The present invention relates to systems and methods for monitoring risk. In particular, embodiments of the invention relate to systems and methods for monitoring and analyzing corporate financial exposure and risk.

### BACKGROUND OF THE INVENTION

The business world is changing. Open economies, widely-available modes of transportation and distribution, and cheap and reliable communications make it easy for companies to conduct business on a national or even international basis. While this can present many lucrative opportunities, it can also present many difficulties in managing a business.

One particularly difficult issue for many large businesses is how to efficiently, accurately, and effectively track and assess the size and nature of financial and legal liabilities (“exposures”) of the business. This can be even more problematic for a business which has multiple operating units with multiple products. Different operating units of the business may interact with the same customers.

For example, one operating unit may lend a customer a large amount of money secured by property held by the customer. A separate operating unit of the business may have lent the same customer a large amount of money secured by other customer property. Tracking the total exposure that the business has with this one customer can become quite difficult when the business has multiple operating units and multiple products. The problem is exacerbated when a customer operates using different business names, and where the operating units classify collateral and products differently. The unfortunate result can be a business which is financially overexposed to one or more customers.

Further, it can be difficult to track and assess the size and nature of the overall exposure of a business based on certain products, types of products, or other characteristics of the various business exposures. It would be desirable to provide a system and method for monitoring exposure which allows tracking of corporate exposure across multiple operating units, multiple products, collateral and customers. It would further be desirable to provide a system and method for ensuring that data received from various operating units is standardized and of appropriate data quality. It would further be desirable to provide a system and method which allows users to receive a variety of different reports regarding exposures of the business.

### SUMMARY OF THE INVENTION

To alleviate the problems inherent in the prior art, and to allow businesses to track, monitor, and analyze exposure data across multiple operating units, products, and customers, embodiments of the present invention provide a system and method as well as computer program code for monitoring and analyzing exposure data.

According to one embodiment, a method for monitoring financial exposure in an entity having a plurality of operating units includes gathering information about each of the operating units including product information and collateral information, and mapping the product information and the collateral information to standardized product information and standardized collateral information. Customer data is received from each of the operating units which identifies at least a first customer of each of the operating units. Unit exposure data is also received which identifies an exposure of the operating unit to the at least first customer. Aggregated exposure information for the entity is generated based on this information.

In one embodiment, the method also includes analyzing received data to ensure that the data meets one or more data standards. In one embodiment, the data standards may be adjusted. According to one embodiment, the method also includes presenting aggregated exposure information in one or more formats for review and analysis.

Embodiments of the present invention also include a device for monitoring financial exposure in an entity having a plurality of operating units, where the device includes a processor, and a communication device, coupled to said processor, receiving product information, collateral information, customer information and unit exposure information from the plurality of operating units, the unit exposure information identifying an exposure of each of the operating units to one or more customers. The device also includes a storage device in communication with the processor and storing instructions adapted to be executed by the processor to generate aggregated exposure data for the entity based on the information received from each of the operating units.

According to another embodiment of the present invention, a computer program product in a computer readable medium for monitoring financial exposure in an entity having a plurality of operating units includes first instructions for receiving information about each of said operating units, including product information and collateral information, second instructions for mapping said product information and said collateral information to standardized product information and standardized collateral information, third instructions for receiving, from each of said operating units, customer data identifying at least a first customer of each of said operating units, fourth instructions for receiving, from each of said operating units, unit exposure data identifying an exposure of said operating unit to said at least first customer of said operating unit, and fifth instructions for generating aggregated exposure information for said entity.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1A is a stylized organizational chart depicting an example organization which may benefit from use of embodiments of the present invention;

FIG. 1B is a block diagram of a system consistent with embodiments of the present invention;

FIG. 2A is a block diagram of an embodiment of the controller of the system of FIG. 1B;

FIG. 2B is a block diagram of an embodiment of the user device of the system of FIG. 1B;

FIG. 3 is a table depicting an exemplary unit database used in the system of FIG. 1B;

FIG. 4 is a table depicting an exemplary product database use d in the system of FIG. 1B;

FIG. 5 is a table depicting an exemplary collateral database used in the system of FIG. 1B;

FIGS. 6A and 6B are a table depicting an exemplary exposure database used in the system of FIG. 1B;

FIG. 7 is a flow diagram depicting an exemplary process for monitoring exposure using the system of FIG. 1B;

FIGS. 8A-B are flow diagrams depicting an exemplary process for mapping data elements in the system of FIG. 1B;

FIG. 9 is a flow diagram depicting an exemplary process for submitting and updating data in the system of FIG. 1B;

FIG. 10 is a flow diagram depicting an exemplary process for presenting and analyzing exposure data in the system of FIG. 1B; and

FIGS. 11A-D are example data screens suitable for presenting exposure data in the system of FIG. 1B.

### DETAILED DESCRIPTION OF THE INVENTION

Applicants have recognized that there is a need for businesses to have an improved ability to monitor and analyze exposure data. In particular, there is a need for an ability to monitor and analyze exposure data in businesses which have a plurality of operating units, a plurality of products, and a plurality of customers.

In addition, Applicants have recognized that there is a need to ensure that data received from the various operating units of the business be verified and accurate and that products, customers, collateral, and operating units be accurately identified in a standardized manner.

A number of terms are used herein, the understanding of which may benefit from a brief explanation. The term “business” is used herein to refer to the entity utilizing features of the present invention to monitor and analyze its various exposures and may be, for example, a corporation, a partnership, a limited liability company, a governmental body or any other type of entity which may benefit from an ability to monitor and analyze its overall exposure as well as individual exposures based on individual product lines or groups within the entity.

As used herein, the term “operating unit” is used to refer to different groups, entities or divisions within a business, such as, for example, wholly or partially owned subsidiaries of the business, regional operating companies, holding companies, divisions, product groups, or the like. In general, embodiments of the invention permit the monitoring of exposure data across any type of operating unit. Operating units may also be referred to as “units” herein.

The term “product” is used herein to refer to any of a number of different commodities or services which are sold, licensed, leased or otherwise used to generate revenue by the business and/or its operating units. Products may include, for example, different types of: loans, leases, equity, investment securities, etc. Further examples will be provided below. As used herein, two general types of product names will be referenced: “business product names” and “standardized product names”. Business product names will refer to the name used by a particular operating unit of the business. Standardized product names will refer to the name used by the business for a particular product or product type.

The term “customer” is used herein to refer to entities which purchase, use, operate, lease, contract for, or otherwise acquire products from the business or one or more of its operating units. A customer may be, for example, a corporation, partnership, individual, sole proprietorship, or any other entity purchasing, using, operating, leasing, contracting for, or otherwise acquiring products and offering collateral to secure obligations.

The term “collateral” is used herein to refer to any tangible or intangible property nominated by a customer to guarantee payment of an obligation, including in particular obligations which arise as a result of transactions involving products of the business or operating units of the business. In some embodiments, embodiments of the present invention are used to track unsecured exposures (e.g., exposures arising from unsecured consumer debt such as credit card debt). In these embodiments, the “collateral identifier” or “collateral information” may simply be information identifying that no collateral has been received (i.e., the debt is unsecured or uncollateralized).

The term “exposure” is used herein to refer to liabilities incurred by a business (directly or through one or more operating units) to a customer. Exposures may be direct or indirect. Direct exposures are exposures incurred directly with a customer, while indirect exposures involve a third party between the customer and the operating unit. Exposures may also include both on-book and off-book types.

Embodiments of the present invention will now be described by first describing the overall system, then describing individual devices and databases, and then by describing processes of embodiments of the invention.

b 1 . System

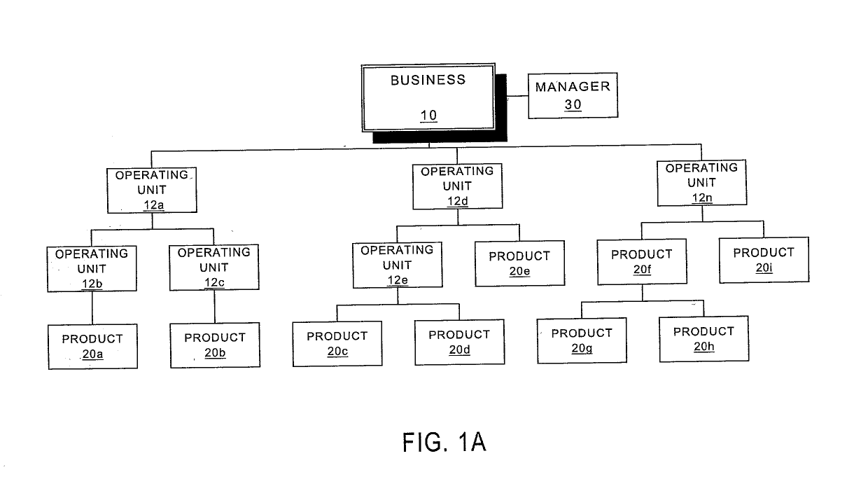

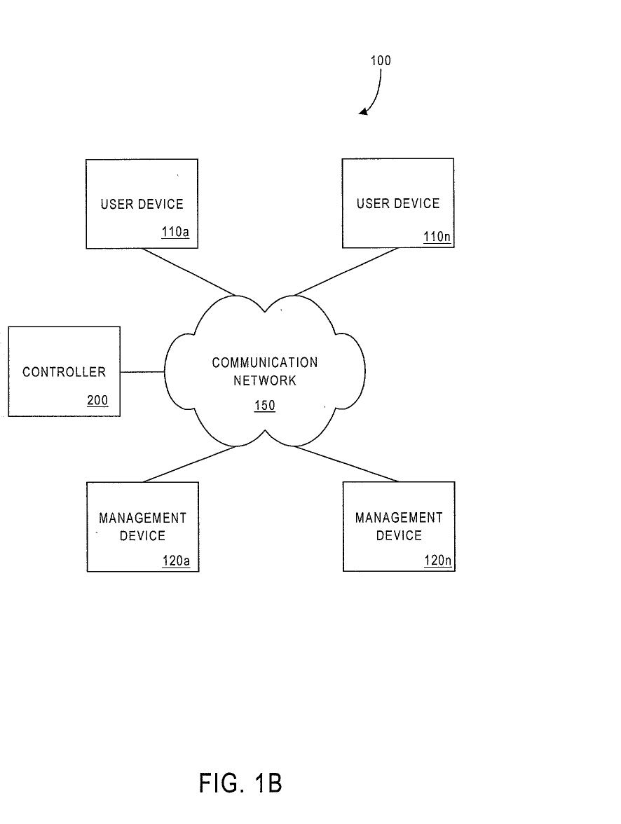

Referring now to the figures, and first to FIG. 1A, an example organizational chart of an example business 10 is shown. Business 10 has multiple operating units 12a-n each of which may further have one or more operating units. A number of products 20a-n are offered by business 10 through its operating units 12. Business 10 may have one or more managers 30 responsible for monitoring exposures of the business. As described above in the background section, prior to Applicant's invention, businesses having a complicated hierarchy such as the hierarchy shown in FIG. 1A had a difficult time tracking, monitoring, and analyzing exposures of the various operating units based on various products of those operating units. Because it was difficult or not possible to track, monitor and analyze exposures of individual operating groups, it was also difficult or not possible to understand the overall exposure of the business. This lack of information and understanding can be potentially devastating to a business. As will be described below, embodiments of the present invention provide a method and system which facilitates the tracking, monitoring and analyzing of exposures in businesses having multiple operating units, multiple products, and multiple customers.

Further reference to FIG. 1A and to this example business structure will be made below to facilitate understanding of embodiments of the present invention. To aid in appreciation of embodiments of the present invention, FIG. 1A will be used to refer to an example business 10 which is a diversified financial services company with a number of different operating units 12 and different products 20.

Referring now to FIG. 1B, a system 100 for monitoring exposure is shown according to one embodiment of the present invention. System 100 includes one or more user devices 110, one or more management devices 120, and at least one controller 200 all in communication over a communication network 150. According to one embodiment, all of the devices 110, 120 and 200 are operated by or on behalf of a business to monitor exposures of the business. In one embodiment, user devices 110 are operated by users at one or more operating units 12 of business 10. Embodiments of the present invention permit a business to monitor exposure across a large number of disparate operating units.

Referring both to FIGS. 1A and 1B, system 100 may be used by a business such as business 10 of FIG. 1A to monitor and analyze exposures of each of the operating units 12a-n based on each of the different products 20a-n. Management device 120 may be operated by management users (such as manager 30 of business 10) to receive and manipulate exposure data generated by system 100. In one embodiment, only users with special access permission may access system 100 via management devices 120 (e.g., a business may choose to only grant access to risk managers or senior management of the business). In some embodiments, only designated individuals may utilize and operate user devices 110 (e.g., designated risk managers at each operating unit may be chosen to enter exposure information into the system).

As an illustrative example, business 10 may be a financial services company which has a consumer credit operating unit, a commercial real estate operating unit, and a consumer real estate operating unit. Each of the three operating units may have a number of different products which generate some exposure to the financial services company. This entity may utilize features of embodiments of the present invention to monitor and analyze exposures across the different operating units and across the different products. Each of the operating units may have one or more user devices 110 which is used to input data and information about the operating unit and about the products, customers, and exposures of the operating unit. The business may have one or more management devices 120 through which the business and/or its operating units may monitor and analyze exposure data. The business may operate one or more controllers 200 to store data and provide functionality of the present invention. In one embodiment, system 100 is established as a Web-based system which may be accessed by user devices 110 and management devices 120.

As used herein, user devices 110, management devices 120 and controller 200 may communicate, for example, via a communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a wireless network, a cable television network, or an Internet Protocol (IP) network such as the Internet, an intranet or an extranet. Moreover, as used herein, communications include those enabled by wired or wireless technology.

Each of the devices 110, 120 and 200 may be any devices capable of performing the various functions described herein. In one currently preferred embodiment, user devices 110 and management devices 120 are personal computers (PCs) or workstations of the type known to those skilled in the art. For example, each user device 110 and management device 120 may be configured to communicate with controller 200 via an intranet of the business or via the Internet or some combination thereof. As will be described below in more detail, each of the devices 110, 120 are typically used to input data and to view and manipulate data which may be stored, for example, at controller 200. This may be accomplished using Web-based techniques to facilitate data entry and ease of operation.

In other embodiments, devices 110, 120 may be other types of computing devices capable of performing the functions described herein, including: a portable computing device such as a Personal Digital Assistant (PDA), a wired or wireless telephone, a one-way or two-way pager, or any other appropriate storage and/or communication device.

In one embodiment, which will be used as an exemplary embodiment throughout the remainder of this disclosure, controller 200 is operated as a central controller accessible by a number of devices 110 and 120 via the Internet or an intranet. In this embodiment, controller 200 stores data input by users operating user devices 110 and manipulates the data for viewing and use by managers operating management devices 120. In this example embodiment, controller 200 is a Web-based controller 200 (e.g., a server) configured to interact with user devices 110 and management devices 120 via the Internet or an intranet.

Upon reading this disclosure, those skilled in the art will recognize that a number of different embodiments and configurations may be used. For example, although one embodiment of the present invention is described with respect to information exchanged using Web-based techniques over a business' intranet and/or the Internet, according to other embodiments information can instead be exchanged, for example, via: a telephone, an Interactive Voice Response Unit (IVRU), electronic mail, a WEBTV® interface, a cable network interface, and/or a wireless communication system. Further, although one embodiment is described where data is centrally stored and accessed by controller 200, other embodiments may utilize distributed storage techniques.

2. Devices

Controller

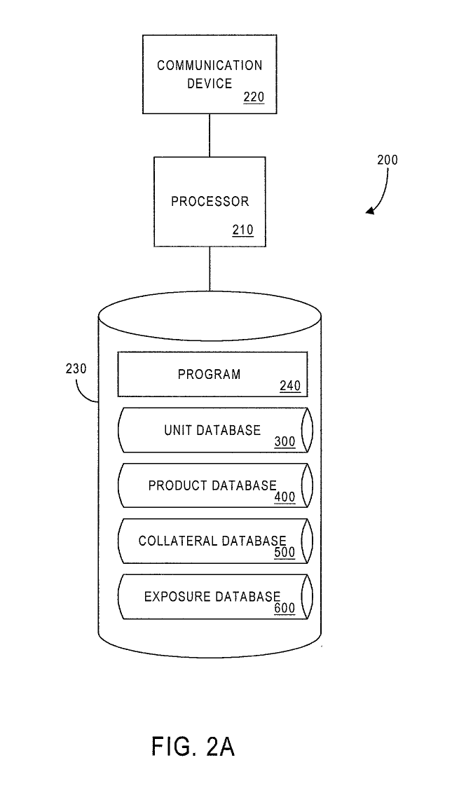

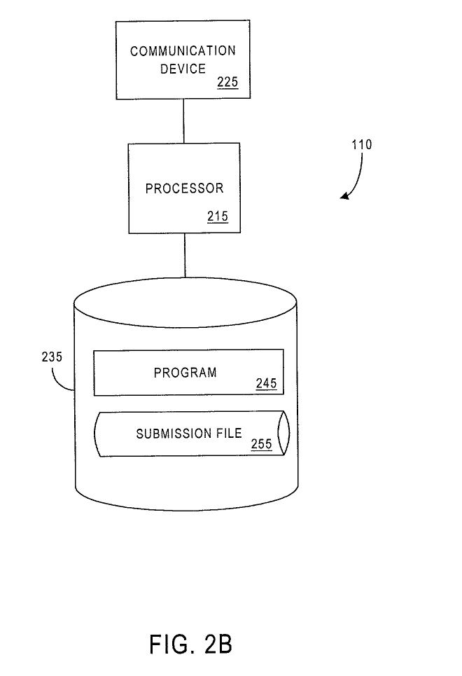

FIG. 2A illustrates an embodiment of controller 200. According to embodiments of the invention, one or more controllers are operated by or on behalf of a business to allow exposure monitoring and analysis. By using conventional network techniques, one or more controllers may be used to allow monitoring and analysis for businesses having one or more operating units conducting business with one or more customers. Controller 200 may be implemented as a system controller, a dedicated hardware circuit, an appropriately programmed general purpose computer, or any other equivalent electronic, mechanical or electro-mechanical device.

Controller 200 comprises a processor 210, such as one or more Intel® Pentium® processors. Processor 210 is coupled to a communication port 220 through which processor 210 communicates with other devices, such as, for example, user devices 110 and management devices 120. Communication port 220 may include hardware and software facilitation communication with other devices using wired or wireless techniques, or a combination of different techniques. For example, communication port 220 may be one or more of: a network adapter, a modem, a Bluetooth chip, etc.

Processor 210 is also in communication with a data storage device 230. Data storage device 230 comprises an appropriate combination of magnetic, optical and/or semiconductor memory, and may include, for example, Random Access Memory (RAM), Read-Only Memory (ROM), a compact disc and/or a hard disk. Processor 210 and data storage device 230 may each be, for example: (i) located entirely within a single computer or other computing. device; or (ii) connected to each other by a remote communication medium, such as a serial port cable, telephone line or radio frequency transceiver. In one embodiment, controller 200 may comprise one or more computers that are connected to a remote server computer for maintaining databases.

Data storage device 230 stores a program 240 for controlling processor 210. Processor 210 performs instructions of program 240, and thereby operates in accordance with the present invention, and particularly in accordance with the methods described in detail herein. Program 240 may be stored in a compressed, uncompiled and/or encrypted format. Program 240 furthermore includes program elements that may be necessary, such as an operating system, a database management system and “device drivers” for allowing processor 210 to interface with computer peripheral devices. Appropriate program elements are known to those skilled in the art, and need not be described in detail herein.

According to an embodiment of the present invention, the instructions of program 240 may be read into a main memory from another computer-readable medium, such from a ROM to RAM. Execution of sequences of the instructions in program 240 causes processor 210 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

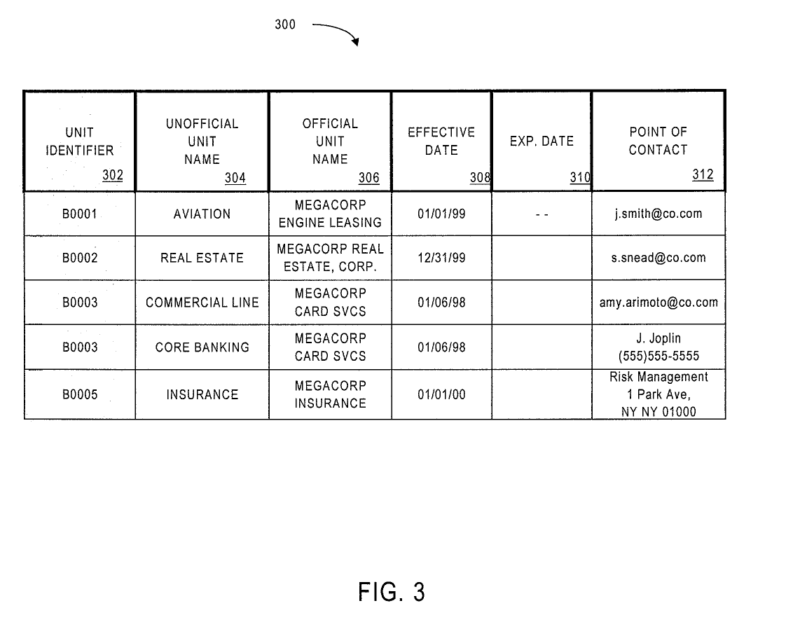

Data storage device 230 also stores (i) a unit database 300, (ii) a product database 400, (iii) a collateral database 500, and (v) an exposure database 600. Each of the databases 300, 400, 500 and 600 are described in detail below (starting with the description of FIG. 3 below) and depicted with exemplary entries in the accompanying figures. As will be understood by those skilled in the art, the schematic illustrations and accompanying descriptions of the databases presented herein are exemplary arrangements for stored representations of information. A number of other arrangements may be employed besides those suggested by the tables shown. Similarly, the illustrated entries of the databases represent exemplary information only; those skilled in the art will understand that the number and content of the entries can be different from those illustrated herein.

User Devices

FIG. 2B illustrates an embodiment of user device 110. In one embodiment, user device 110 is configured in a similar manner as controller 200 with a processor 215 coupled to a communication port 225 through which processor 215 communicates with other devices, such as, for example, controller 200. Processor 215 may also be in communication with a data storage device 235 which stores a program 245 for controlling processor 215. Data storage device 235 also stores a data submission file 255.

In one embodiment of the present invention, each individual operating unit of a business periodically generates data recording all of that operating unit's products, customers, and exposures. This information is stored in data submission file 255. This information may be stored in any of a number of different formats, including, for example, in a delimited text file, in a spreadsheet file, a database, etc. Much of the information from data submission file 255 may be used to generate one or more of the databases stored at controller 200 and which will be described in more detail below. In some embodiments, individual data submission files need not be stored at each user device 110, rather, the information may be transmitted to and stored at controller 200.

3. Databases

Unit Database

Referring now to FIG. 3, a table represents a unit database 300 that may be stored at controller 200 according to an embodiment of the present invention. The table includes entries which provide information to identify different operating units of a business. For example, referring to the example organizational chart of FIG. 1A, different operating units identified in unit database 300 may include each of the different operating units 12a-n of business 10. In particular, the operating units identified in unit database 300 preferably include those operating units of a business which have some exposure to one or more customers.

The table also defines fields 302, 304, 306, 308, 310 and 312 for each of the entries. The fields specify: a unit identifier 302, an unofficial unit name 304, an official unit name 306, an effective date 308, an expiration date 310, and a point of contact 312. The information in unit database 300 may be created and updated, for example, based on information received from individual operating units of a business. In one embodiment, which will be described in further detail below, the information may be input into database 300 as a result of a unit mapping process performed periodically. The information in database 300 may also be based on, for example, information periodically created by the business to keep track of different operating units of the business.

Unit identifier 302 may be, for example, an alphanumeric code or other identifier associated with a particular operating unit which has one or more exposures which are to be monitored using embodiments of the present invention. Unit identifier 302 may be automatically generated by, for example, controller 200 and assigned to each operating unit or the identifier may be generated and assigned by the business for each operating unit of the business.

Unofficial unit name 304 may include data representing an alternative identifier by which the operating unit identified by unit identifier 302 may be known. For example, in many businesses, individual operating units may refer to themselves using a trade name or group name which is not exactly the same as the formal name used by the business to refer to the operating unit. This can make it difficult to monitor exposures for the entire business, and also makes it difficult to monitor exposures for individual operating units. By associating the unofficial unit name 304 with the official unit name 306, businesses using embodiments of the present invention can ensure that they have accurate information regarding the overall exposures of each of the operating units of the business, as well as the overall exposure of the business itself. Official unit name 306, thus, may be information identifying operating units of the business which information is periodically established by the business to reflect the overall business hierarchy and structure.

Effective date 308 may be the date on which the operating unit identified by unit identifier 302 came into existence, or it may be the date on which the business began tracking exposures for the operating unit identified by unit identifier 302.

Expiration date 310 may be information identifying a date on which the particular unofficial unit name identified by unit identifier 302 has expired. For example, an operating unit may refer to itself as “PROPERTY INSURANCE” for a period, then it may change and begin referring to itself as “INSURANCE”. The date that the old name is obsolete may be the date that the old name is “expired” by entering an expiration date 310. This allows the system to track multiple operating units which refer to themselves by a changing series of names.

Point of contact 312 may be information identifying an individual or group which is the designated point of contact for the operating unit identified by unit identifier 302. Information identifying the point of contact may be automatically captured by system 100 when information is input from user device 110. Other information identifying individual operating units of a business may be entered in database 300.

Product Database

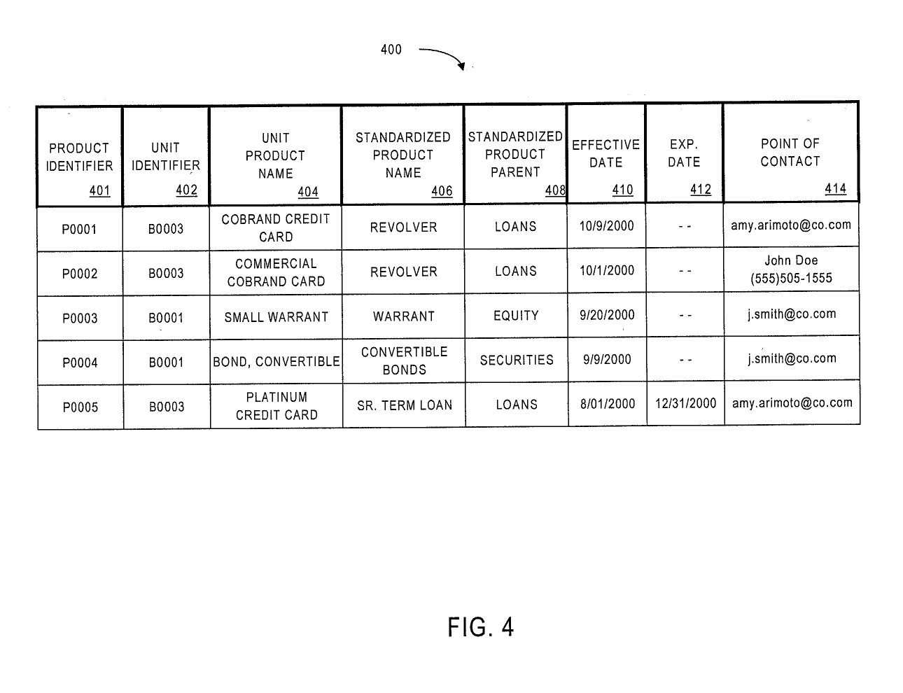

Referring now to FIG. 4, a table represents a product database 400 that may be stored at controller 200 according to an embodiment of the present invention. The table includes entries identifying a number of different products offered by different operating units of a business. In particular, the products identified in product database 400 preferably include products through which operating units have some exposure to one or more customers.

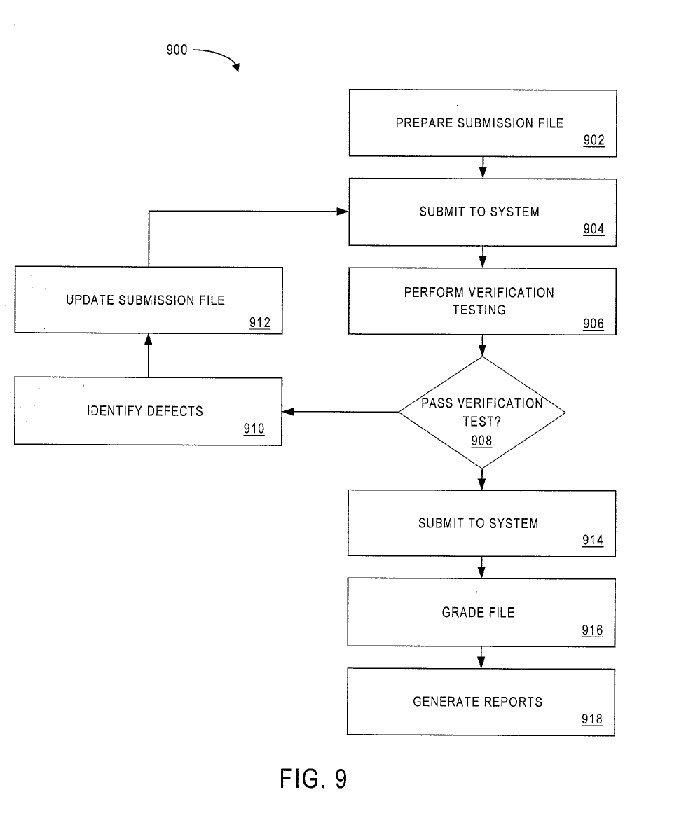

The table also defines fields 401, 402, 404, 406, 408, 410, 412 and 414 for each of the entries. The fields specify: a product identifier 401, a unit identifier 402, a unit product name 404, a standardized product name 406, a standardized product parent 408, an effective date 410, an expiration date 412, and a point of contact 414. The information in product database 400 may be created and updated, for example, based on information received from individual operating units of a business. In one embodiment, which will be described in further detail below in conjunction with FIG. 9A, the information may be input into database 400 as a result of a product mapping process which may be performed on a periodic basis. The information in database 400 may also be based on, for example, information periodically created by the business to keep track of different products of the business.

Product identifier 401 may be an alphanumeric code or other identifier used to particularly identify a specific product of an operating unit. Product identifier 401 may be automatically generated by, for example, controller 200 and assigned to each product when the product is first identified by a user operating user device 110, or the identifier may be otherwise selected by the business or by an individual operating unit.

Unit identifier 402 may be the same as, or related to, the unit identifier 302 of FIG. 3 and is an identifier associated with a particular operating unit which offers the product identified by product identifier 401. Unit identifier 302 may be automatically generated by, for example, controller 200 and assigned to each operating unit or the identifier may be generated and assigned by the business for each operating unit of the business.

Unit product name 404 may be information used by the operating unit identified by unit identifier 402 to refer to the product identified by product identifier 401. Standardized product name 406 is a product name established by the business for tracking a particular type of product, while standardized product parent 408 is a generic name for a particular group of products. These fields are used to help ensure that standardized nomenclature is used to identify products of business 10. Because many operating units refer to their products using informal or non-standardized nomenclature, it can be difficult for a business to track exposures related to all of its products across all of its operating units. Correlating informal or unit product names to standardized product names is one way to allow a business to track all of its products.

For example, as shown in the table of FIG. 4, an operating unit may refer to a credit card product as a “COBRAND CREDIT CARD” or as a “PLATINUM CARD” or some other brand name. The business, on the other hand, may prefer to understand the total exposure it has with respect to all “LOANS” which are “REVOLVERS”. By mapping informal unit product names 404 with standardized product names 406 the business is able to more closely and accurately monitor exposures that its operating units have incurred in relation to particular types of products. Further, by mapping unit business products to particular standardized product parents, the business can aggregate or assess exposure information across types of products.

Effective date 410 may be the date on which the product identified by product identifier 401 is first introduced, or the date on which the operating unit identified by unit identifier 402 first incurred some exposure with respect to that particular product.

Expiration date 412 may be the date on which the product identified by product identifier 401 has been expired. For example, authorized users or agents of different operating units may periodically enter product expirations into database 400. This may be done, for example, if the operating unit is changing the name of a product. In this case, the expiration date of the old product name will be the same as the effective date of the new product name.

Point of contact 414 may be an individual or group identified as the point of contact for the product identified by product identifier 401. In some embodiments, the point of contact information is automatically captured from user device 110 when product data is being entered by an operator of user device 110. Those skilled in the art will recognize that other information regarding different products may also be stored or associated with product database 400.

Collateral Database

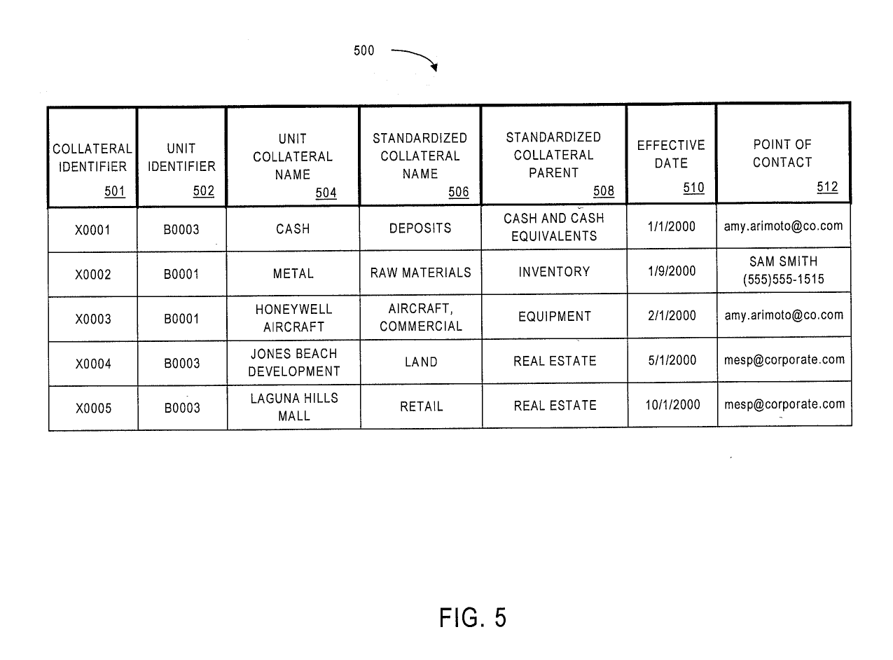

Referring now to FIG. 5, a table represents a collateral database 500 that may be stored at controller 200 according to an embodiment of the present invention. The table includes entries identifying a number of different items of collateral received by different operating units of a business. In particular, the different collateral items identified in collateral database 500 preferably include any type of collateral which has been pledged by a customer of an operating unit of the business in exchange for a product offered by the operating unit.

The table also defines fields 501, 502, 504, 506, 508, 510, and 512 for each of the entries. The fields specify: a collateral identifier 501, a unit identifier 502, a unit collateral name 504, a standardized collateral name 506, a standardized collateral parent 508, an effective date 510, and a point of contact 514. The information in collateral database 500 may be created and updated, for example, based on information received from individual operating units of a business. In one embodiment, which will be described in further detail below in conjunction with FIG. 9B, the information may be input into collateral database 500 as a result of a collateral mapping process which may be performed on a periodic basis. The information in collateral database 500 may also be based on, for example, information periodically created by the business to keep track of different items of collateral received by operating units of the business.

Collateral identifier 501 may be, for example, an alphanumeric code or other identifier associated with a particular item of collateral taken by an operating unit. Collateral identifier 501 may be automatically generated by, for example, controller 200 and assigned to an item of collateral when it is first identified to the controller, or it may be otherwise assigned by the business or individual operating units.

Unit identifier 502 may be the same as, or related to, the unit identifier 302 of FIG. 3 and is an identifier associated with a particular operating unit which has taken an interest in the collateral identified by collateral identifier 501. Unit identifier 502 may be automatically generated by, for example, controller 200 and assigned to each operating unit or the identifier may be generated and assigned by the business for each operating unit of the business.

Unit collateral name 504 may be information provided by an operating unit to further identify the collateral identified by collateral identifier 501. Standardized collateral name 506 may be information provided by the business to establish standardized terminology for a particular type of collateral. By providing both the unit's name for the collateral and the business' standardized name for the collateral, embodiments of the present invention are able to translate between the two terms. For example, a real estate operating unit of a business may refer to a piece of collateral as the “Jones Beach Development” while the business may refer to it more generically as “Land”. A standardized collateral parent 508 is also provided to further categorize the collateral name. As will be discussed further below in conjunction with FIG. 9B, data entry and mapping to a particular standardized collateral name 506 and parent 508 may be facilitated using data entry menus and forms.

Effective date 510 may be a date representing the date on which the collateral identified by collateral identifier 501 was been mapped to standardized collateral name 506. Effective date 510 may be automatically assigned by controller 200. In some embodiments, an expiration date (not shown) may also be used to track expired collateral names.

Point of contact 512 is information identifying an-individual or entity which may be contacted for questions or information regarding the collateral identified by collateral identifier 501. This information may be automatically captured from user device 110 by controller 200 when collateral data is entered. Those skilled in the art will recognize that other information and data relating to individual items of collateral may be captured and stored in or made available to collateral database 500.

Exposure Database

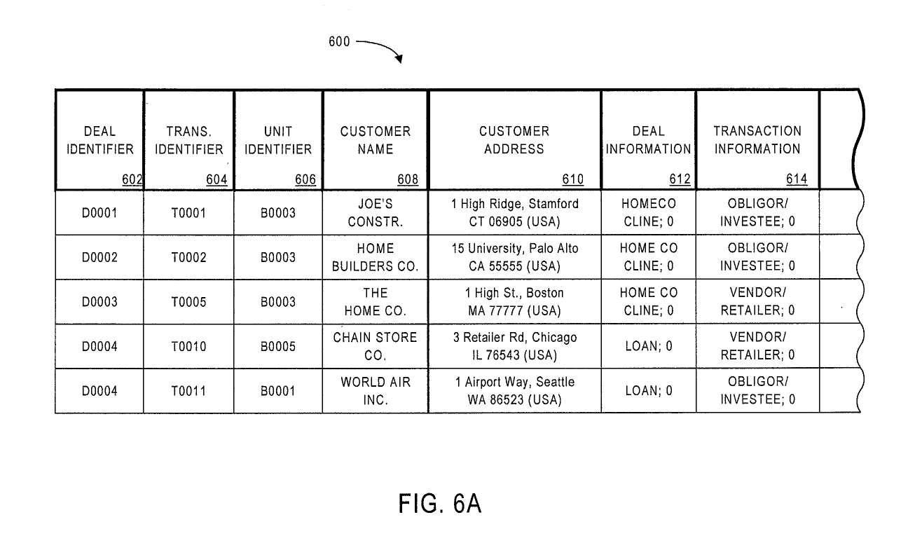

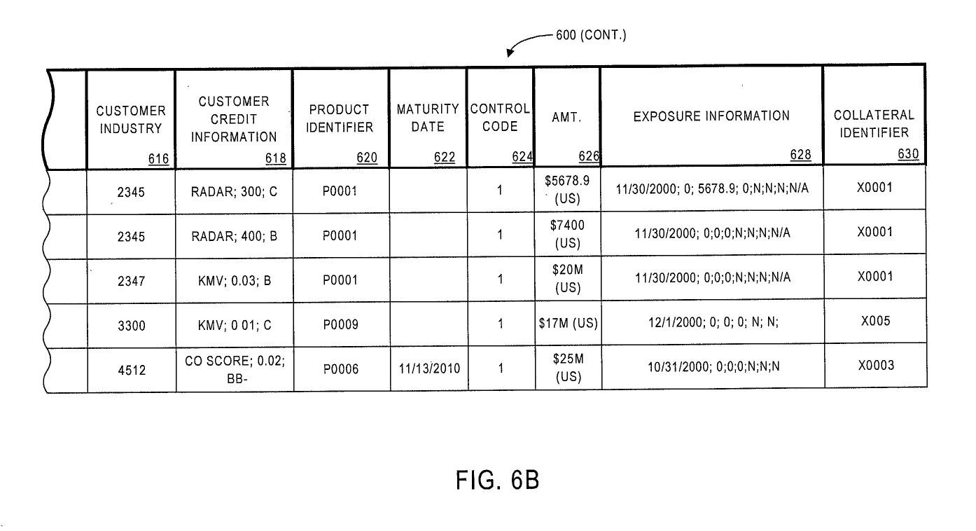

Referring now to FIGS. 6A and 6B, a table represents an exposure database 600 that may be stored at controller 200 according to an embodiment of the present invention. The table includes entries identifying a number of different individual exposures of operating units of a business. In particular, the different exposures identified in exposure database 600 preferably include all active (non-expired) exposures of the business, across all operating units of the business.

The table also defines fields 602-630 for each of the entries. The fields specify: a deal identifier 602, a transaction identifier 604, a unit identifier 606, a customer name 608, a customer address 610, deal information 612, transaction information 614, a customer industry 616, customer credit information 618, a product identifier 620, a maturity date 622, a control code 624, an exposure amount 626, exposure information 628 and a collateral identifier 630. In one embodiment, this information is generated and input on a regular basis using the process which will be described below in conjunction with FIG. 9.

Deal identifier 602 may be, for example, an alphanumeric code or other identifier associated with a particular deal involving an operating unit of the business for which the business experiences some exposure or risk. This information may be automatically generated by controller 200 or may be selected or established by individual operating units. Each deal identified by deal identifier 602 may have multiple individual transactions associated with it that generate some exposure to the business.

These individual transactions are identified by a transaction identifier 604 which may be, for example, an alphanumeric code or other identifier associated with a particular transaction associated with a deal identified by deal identifier 602. In some embodiments, a deal may have only a single transaction, in which case the transaction identifier and the deal identifier may be the same. Transaction identifier 604 may be automatically generated by controller 200 or may be selected or established by individual operating units.

Unit identifier 606 may be the same as, or related to, the unit identifier 302 of FIG. 3 and is an identifier associated with a particular operating unit which is a party to the transaction identified by transaction identifier 604. The other party to the transaction, the customer, is identified by customer name 608. Customer name 608 may be, for example, the corporate or legal name of the customer. Preferably, customer name 608 is the legal entity to which the business has an exposure. Customer address 610 is an address of the customer identified by customer name 608 and is preferably the corporate address or an address of a designated legal agent of the customer. Customer address 610 may include a variety of information, such as information indicating the nature of the address (e.g., corporate headquarters, legal department, etc.), telephone numbers, electronic mail addresses, etc.

Often, customers use different business names or have multiple corporate affiliates. In one embodiment of the present invention, an analysis of customer information, including the customer name 608 and address 610, is performed to attempt to identify aliases of a customer. In addition, analysis of outside data sources may also be performed to identify aliases of a customer. For example, a large business may have a corporate name “BIG CO.” and a corporate address of 1 High Street, Armonk, N.Y. 88888. BIG CO. may also have an affiliate, “BIG CO LEASING” having a different address. Embodiments of the present invention may attempt to associate these two entities by referring to an outside source such as Dunn & Bradstreet, to identify BIG CO LEASING as a corporate affiliate of BIG CO. This allows the system 100 to accurately identify the ultimate customer of the business. As a result, accurate tracking of exposures to the ultimate customer may be achieved.

Deal information 612 may include information identifying details of the deal identified by deal identifier 602. For example, deal information 612 may include a deal name used by the operating unit to refer to the deal and a deal status indicating whether the deal is open or terminated (e.g., in the table, a “0” indicates that the deal is open or active and a “1” indicates that the deal is closed -or terminated).

Transaction information 614 includes information identifying details of the particular transaction identified by transaction identifier 604. For example, transaction information 614 may include information identifying the role the customer plays in the transaction. A transaction can have more than one customer role, although a transaction can only have one customer acting as the “OBLIGOR/INVESTEE”. Example roles include: obligor/investee; liquidity provider; agent bank; partner; project offtake counterparty; derivative counterparty; developer; operator/servicer; vendor/retailer; principal; special purpose beneficiary; secondary receivable exposure; etc. These different roles may be used, as will be discussed further below, to specifically analyze and monitor particular types of exposures that arise throughout the business.

Customer industry 616 may be, for example, information identifying the particular industry in which the customer identified by customer name 608 conducts business. For example, this may be a two or four digit standard industry code (SIC) or some other information designating the type of industry in which the customer does business. This information may be used to assist in the analysis of the exposure of business 10.

In addition to customer industry 616, other classifying information may also be used to further classify one or more customers identified by customer name 608. For example, in one embodiment, a customer may be categorized into classifications of current interest to the business (e.g., the business may be interested in particularly analyzing exposure data for customers in areas such as “small business”, “telecom”, “healthcare”, “e-business”, etc.). These additional classifications may be modified and updated as the business evolves and as exposures in different areas of interest evolve. This information may be stored, for example, in exposure database 600. Particular customers may be classified in one or more of these additional categories (e.g., one operating unit may have exposure to a customer in a telecom deal, while another operating unit may have exposure to that same customer in a healthcare deal).

Customer credit information 618 may be information identifying a particular credit analysis of the customer identified by customer name 608. This information may include information identifying a particular credit scoring system used to generate a score, the particular score generated for the customer, and a credit rating of the customer.

A number of different credit scoring systems may be used to generate credit information about customers including proprietary systems (represented in FIG. 6 as “RADAR” or “CO. SCORE”) as well as publicly-available fee based systems offered by entities such as KMV LLC. of San Francisco, Calif., or Standard & Poors of New York, N.Y., or the like.

Information identifying a particular credit score may also be stored in customer credit information 618, and may be information generated by the credit scoring system identified in field 618. This number will vary based on the type of scoring system used. Credit rating information may also be included. Not all scoring systems generate a credit rating, so not all customers need have information in this field.

Product identifier 620 may be the same as or related to product identifier 401 of product database 400, and is information identifying the particular product involved in the deal identified by transaction identifier 704.

Maturity date 622 includes information identifying the date that the transaction identified by transaction identifier 604 matures. This date is typically specified by the legal documents and contracts establishing the terms of the transaction between an operating unit and a customer. If a maturity date is provided in an agreement, the date should be included in field 622; if no date is specified in the agreement, population of this field may not be necessary. For certain types of transactions (e.g., transactions involving products such as preferred stock or common stock) a default maturity date may be provided by controller 200.

Control code 624 includes information identifying a level of decision-making authority an operating unit has over a particular transaction. Example control codes may include: “(1) Sole Participant” (where the operating unit has a great deal of control over decision making); “(2) Active Partner”; “(3) Agent for Others”; or “(4) Passive Participant” (where the operating unit has a low level of control over decision making).

Exposure amount 626 includes information identifying a particular dollar value of exposure relating to the transaction identified by transaction identifier 604. In one embodiment, this exposure amount 626 represents the total exposure amount at the end of the transaction. In some embodiments, exposure amount 626 includes information identifying the two or three digit currency code of the amount shown in 626. Preferably, exposure amount 626 is reported in the functional currency of the books and records in which the transaction identified by transaction identifier 604 is reported.

Exposure information 628 includes a variety of information further specifying the status and nature of the exposure for the transaction identified by transaction identifier 604. For example, exposure information 628 may include: a period ending date (specifying the fiscal close date for the exposure or the last day of the reporting period for the transaction); a 30-59 day past due amount (showing aged receivables not received as of the date of submission); a 60-89 day, past due amount (again showing aged receivables); a 9030 day past due amount (showing aged receivables); a negative watch indicator (indicating whether the customer has been put on a negative watch list by the business); a non-earning status indicator (indicating whether the operating unit has stopped accruing income on the transaction); and a money lost indicator (indicating whether the business has lost money to this particular customer). Those skilled in the art will recognize that additional (or fewer) details may be included as exposure information 628 to provide further details about the nature of an exposure based on the transaction identified by transaction identifier 604.

Collateral identifier 630 includes information identifying the collateral used to secure the transaction identified by transaction identifier 602 and is preferably the same as or related to collateral identifier 501 of FIG. 5.

Upon reading this disclosure, those skilled in the art will recognize that other information identifying particular transactions, deals, and exposures of operating units may be stored in database 600.

4. Process

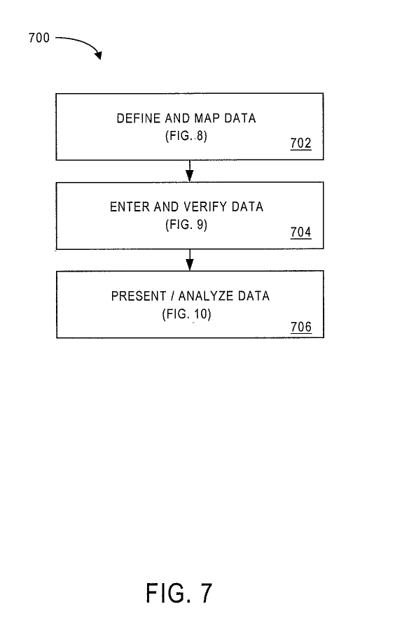

A description of various processes and methods of embodiments of the present invention will now be provided by first referring to FIG. 7, where a process 700 for monitoring and analyzing exposure data is shown. This process may be performed by the system of FIG. 1B to monitor and analyze exposure data for a business such as the business 10 of FIG. 1A.

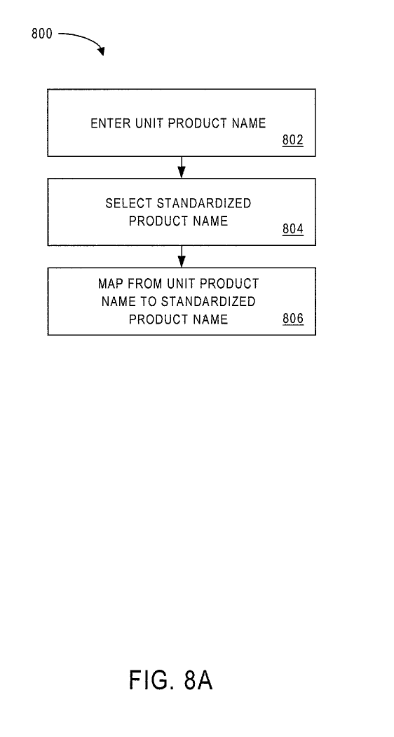

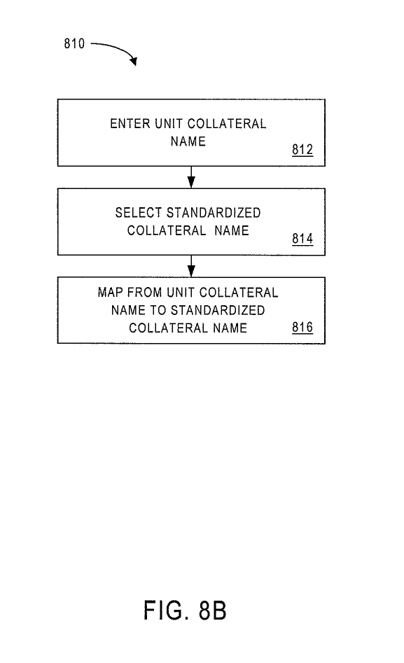

In general, processing begins at 702 where input data is defined and mapped. This data definition and mapping process may include some steps which are performed once or infrequently as well as steps which are performed on a regular basis. For example, processing at 702 may involve receiving and updating information identifying individual operating units of a business and individual products of a business. This information may be input relatively infrequently, and only as information about operating units or products changes. Other information and data may be defined and mapped more frequently. Details about mapping and definition of data are provided below in conjunction with a description of FIG. 8, where the mapping will be presented in three different figures (product mapping, collateral mapping, and operating unit mapping).

Processing continues at 704 where transaction data is entered and verified. This data entry, in one embodiment, involves the periodic generation (e.g., weekly or monthly) of a data submission file by individual operating units. The data submission file is forwarded to controller 200 for data verification. The process may be repeated until the data in the data submission file is verified. This process will be described below in more detail in conjunction with a description of FIG. 9.

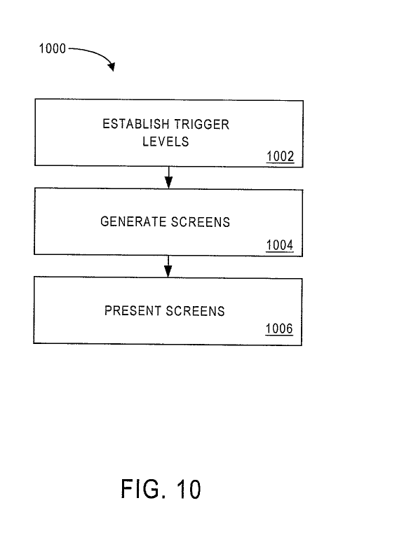

Once data has been received from all relevant operating units of a business (e.g., all operating units which have entered into transactions with customers that generate exposure to the business), processing may proceed to 706 where data is analyzed. A wide variety of types of analysis may be performed on data collected using techniques of the present invention. This analysis will be described further below in conjunction with a description of FIG. 10.

Processing continues at 708 where analyzed data is presented to allow, for example, a manager operating management device 120 (FIG. 1B) to monitor and analyze exposures of the business. This presentation of data will be described further below in conjunction with FIG. 10. Embodiments of the present invention permit a business with multiple operating units and multiple products which result in a number of different exposures, to monitor these different exposures across the business.

Product Mapping

Referring now to FIG. 8A, a description of a process 800 for mapping product names is shown. According to one embodiment of the invention, system 100 may be used in an environment (such as the business structure shown in FIG. 1B) where a business 10 has multiple operating units 12 and multiple products 20. It can often be difficult for a business to track individual products and exposures related thereto because there is no standardized product name for many products. For example, an operating unit may refer to a particular consumer product as “COBRAND CREDIT CARD”, while the business may refer to that type of product as a “REVOLVER” in the family of products referred to as “LOANS”. Because of differences in nomenclature, it can be difficult for a business to monitor and analyze exposures at a product level. Embodiments of the invention address this problem by providing a mapping process 800.

In one embodiment, process 800 may be initiated by operating unit 12 on a periodic basis (e.g., weekly or monthly), each time the operating unit introduces a new product, or on some other cycle chosen by the business 10 or each operating unit 12. In one embodiment, process 800 is initiated by a user operating user device 110 to enter data. The user may be prompted to enter data via a sequence of data input screens which force the user to enter the data in a standardized manner. Data entered by this process may be stored, in one embodiment, at controller 200.

Processing begins at 802 where a unit product name is entered. The unit product name may be a name chosen by operating unit 12 for the product, and may be entered to populate field 404 of product database 400 (FIG. 4). In one embodiment, a user of user device 110 may be presented with a list of all active unit product names for the operating unit and the user need only select from the list of active names. In one embodiment, a Web-based link may be provided to details about each of the unit product names to facilitate mapping by a user. Using an example from product database 400 (FIG. 4), the user may select the unit product name “COMMERCIAL COBRAND CARD” for mapping.

Once the user has selected the desired unit product name to map, processing continues to 804 where the user selects a standardized product name (field 406 of FIG. 4) to associate with the selected unit product name. A listing of standardized product names may be presented to the user at user device 110 along with details about each standardized product name. Continuing the example from product database 400 (FIG. 4), the user following instructions presented at user device 110, will determine that the unit product “COMMERCIAL COBRAND CARD” is a “REVOLVER” in the jargon of business 10's standardized product names. In some embodiments, the user will also be prompted to select a standardized product parent (field 408 of FIG. 4) to further categorize the unit product name. Again, the user of user device 110 may be offered a list of potential standardized product parents to select from. Continuing the example, the user may determine that the unit product “COMMERCIAL COBRAND CARD” is “REVOLVER” in the product family “LOANS”. In one embodiment, the standardized product parent will be determined first, then the standardized product name will be determined.

Businesses may establish a number of different standardized product parents based on the nature of their product lines. For example, a business which is a diversified financial services business may have the following standardized product parents: loans, leases, equity, investment securities, other contingent exposures, securitization support, derivatives, and other financings, etc.

Depending on their needs and products, businesses may establish a number of standardized product names within each standardized product parent. A number of examples of standardized product names for a diversified financial services business may include: (1) (within the loan product parent) revolver, short term loan, subordinated debt, quasi lease, conditional sale, other term loan, etc.; (2) (within the lease product parent) short term rental, operating lease, equipment service contract, single investor lease, leveraged lease; (3) (within the equity product parent) warrants, preferred stock, common stock, fund equity, JV and partnerships; (4) (within the investment securities product parent) common stock-public equity, short term securities, MBS/MBO, CLO/CBO/ABS, high yield bonds, convertible bonds, private placements, treasury, agencies, I/O strips, other securities; (5) (within the other contingent exposures product parent) funding commitments, letters of credit, financial guarantees, liquidity lines, letters of credit by third parties, financial insurance by third parties, financial guarantees by third parties; (6) (within the securitization support product parent) securitization support; (7) (within the derivatives product parent) swap, forward, option, other derivatives; and (8) (within the other financings product parent) trade payable, factoring, intangibles, maintenance/service contracts.

Additional information regarding the unit product identified by the unit product name entered above may also be captured at this stage. For example, other fields of FIG. 4 may be captured, including the unit identifier 402, effective date 410, expiration date 412, and point of contact 414. Those skilled in the art will recognize that other details may be provided to further categorize or identify products of different operating units of a business.

Upon completion of process 800, data is stored (e.g., in product database 400) which maps or otherwise associates product nomenclature from individual operating units with product nomenclature of the business, allowing exposure information to be tracked and analyzed at the product level.

Collateral Mapping

Referring now to FIG. 8B, a further mapping process 810 for mapping collateral names is shown. According to one embodiment of the invention, system 100 may be used in an environment (such as the business structure shown in FIG. 1B) where a business 10 has multiple operating units 12 and multiple products 20. Each of these multiple operating units may receive different types and forms of collateral to secure obligations by different customers. This can make it quite difficult for a business to monitor and analyze its exposure. This is made even further difficult by the use of different terms to refer to and categorize different types of collateral. For example, an operating unit which lends money to commercial aircraft operators may refer to a particular unit of collateral as “HONEYWELL AIRCRAFT”, while another operating unit which takes aircraft as collateral may refer to the collateral as “BOEING AIRCRAFT”. To allow a business to monitor and analyze these types of exposures, Applicants have developed a mapping process to map collateral to standardized collateral names and parents.

In one embodiment, process 810 may be initiated by operating unit 12 on a periodic basis (e.g., weekly or monthly), each time the operating unit accepts collateral in a transaction, or on some other cycle chosen by the business 10 or by operating unit 12. In one embodiment, process 810 is initiated by a user operating user device 110 to enter data. The user may be prompted to enter data via a sequence of data input screens which force the user to enter the data in a standardized manner. Data entered by this process may be stored, in one embodiment, at controller 200 in collateral database 500 (shown in FIG. 5).

Processing begins at 812 where a unit collateral name is entered. The unit collateral name may be a name chosen by operating unit 12 to refer to a particular item of collateral, and may be entered to populate field 504 of collateral database 500 (FIG. 5). In one embodiment, a user of user device 110 may be presented with a list of all active unit collateral names for the operating unit and the user need only select from the list of active names. In one embodiment, a Web-based link may be provided to details about each of the unit collateral names to facilitate mapping by the user. Using an example from collateral database 500 (FIG. 5), the user may enter the unit collateral name “HONEYWELL AIRCRAFT” for mapping.

Once the user has entered the desired unit collateral name to map, processing continues to 814 where the user selects a standardized collateral name (field 506 of FIG. 5) to associate with the entered unit collateral name. A listing of standardized collateral names may be presented to the user at user device 110 along with details about each standardized collateral name. Continuing the example from FIG. 5, the user may determine that the unit collateral name “HONEYWELL AIRCRAFT” should be mapped to the standardized collateral name “AIRCRAFT, COMMERCIAL”.

In one embodiment, each unit collateral name is further mapped to a standardized collateral parent (field 508 of FIG. 5). The user may be presented with a variety of standardized collateral parents from which to choose. In the example, the user may determine that the unit collateral named “HONEYWELL AIRCRAFT” is properly associated with the standardized collateral parent named “EQUIPMENT”. According to an embodiment of the invention, a user may be guided through this process with specific details and guidance on the types of collateral that are properly categorized in each parent category.

Businesses may establish a number of different standardized collateral parents based on the nature of collateral the business typically receives. For example, a business which is a diversified financial services business may have the following standardized collateral parents: cash and cash equivalents, receivables, inventory, securities, equipment, real estate, and multiple collateral types.

Depending on their needs and products, businesses may establish a number of standardized collateral names within each standardized collateral parent. A number of examples of standardized collateral names for a diversified financial services business may include: (1) (for the cash and cash equivalents parent) deposits, escrows, cash reserve, life insurance surrender value; (2) (for the receivables parent) trade receivables and multiple receivables; (3) (for the inventory parent) raw materials, work in progress, finished goods, natural resources, multiple inventories; (4) (for the securities parent) stock, other securities; (5) (for the equipment parent) commercial aircraft, corporate aircraft, aircraft engines, auto and parts, chassis, computers, computer software, construction equipment, containers, electronics, facilities, flight simulators, food and agricultural equipment, furniture and fixtures, healthcare equipment, locomotives and parts, manufacturing equipment, middle market equipment other, mining equipment and oil rigs, modular buildings, power plant, office equipment, printing and publishing equipment, railcars and parts, ships, satellite transponders, telecom equipment, telecom facilities, trucks and parts, trailers, multiple equipment types,; (6) (for the real estate parent) assigned mortgage, condo, hospital, hotel, industrial, land, marina, mini-storage, mixed multi-family/office, mixed multi-family/retail, mixed retail/office, mixed office/industrial, mobile home park, multi-family, office, parking garage, partnership pledges, REIT shares, retail, senior living, single family homes, student housing, multiple real estate, other real estate; and (7) (for the multiple collateral type parent) blanket lien, and multiple collateral types.

Additional information regarding the unit collateral identified by the unit collateral name entered above may also be captured at this stage. For example, other fields of the collateral database 500 shown in FIG. 5 may be captured, including the unit identifier 502, effective date 510 and point of contact 512. Those skilled in the art will recognize that other details may be provided to further categorize or identify collateral of different operating units of a business.

Once the user has selected an appropriate standardized collateral parent and standardized collateral name, processing continues to 816 where data is stored (e.g., in collateral database 500) to associate the unit collateral name with the standardized names.

Embodiments of the present invention may utilize other mapping or standardization processes which ensure that multiple operating units enter data in a standardized manner. For example, according to one embodiment, unofficial unit names may be mapped or translated to official unit names. Often, operating units may refer to themselves in a non-standard way. For example, an aviation subsidiary of a financial services company may simply refer to itself as “AVIATION” or “AVIATION SERVICES” (or both, depending on the circumstances). Business 10, on the other hand, may refer to the operating unit as “MEGACORP ENGINE LEASING”. Differences in nomenclature can make it difficult for a business to monitor and analyze risk across different operating units. Embodiments of the present invention solve this problem, in part, by providing a mapping process which ensures that operating units utilize the proper, or official, unit name rather than unofficial unit names.

This mapping process may occur prior to the two above-mentioned mapping processes or at other times where a user operating user device 110 desires to enter an unofficial unit name for mapping. In one embodiment, the user is prompted to select from a listing of official unit names. The user may be prompted to select further details to describe a particular unit. For example, a user entering data regarding an aviation services entity may be first select the official unit name “AVIATION SERVICES”, and then be prompted to select further details to specifically identify the particular unit (e.g., the user may be prompted to select between “NORTH AMERICA” and “INTERNATIONAL”, and then to further select between “WIDE BODY” and “NARROW BODY” to fully specify and identify the particular operating unit). This information is stored, for example, in unit database 300 at controller 200. In some embodiments, an operating unit may have several aliases or different unofficial unit names; each of these unofficial unit names may be mapped to an official unit name to ensure that exposure data for each of those aliases may be monitored and analyzed properly.

Additional information regarding each unit may be captured at this stage. For example, data for other fields of unit database 300 shown in FIG. 3 may be captured or generated, including the unit identifier 302, effective date 308 and point of contact 310. Those skilled in the art will recognize that other details may be provided to further categorize or identify different operating units of a business.

Data Entry and Verification Process

Referring now to FIG. 9, a process 900 for data entry and verification is depicted. Process 900, according to one embodiment of the present invention, may be followed periodically (e.g., weekly, monthly, etc.) by individual operating units 12 of business 10 to submit current data regarding exposures of each operating unit 12. This information may then be used (as will be described in further detail below in conjunction with FIG. 10) by business 10 to monitor and analyze exposure data for the business.

Process 900 begins at 902 where each operating unit 12 prepares a submission file containing data regarding the operating unit's exposures. This data submission file may be maintained at a user device 110 at operating unit 12 and may include information about each transaction entered into by operating unit 12 which is current (e.g., not expired) and which has generated some exposure for operating unit 12 and business 10. The data submission file, in one embodiment, contains information needed to populate databases accessible by controller 200 including, for example, exposure database 600 (FIG. 6). This data submission file may be maintained in any format convenient for each operating unit, including, for example, as delimited text files, database files, spreadsheets, etc. Preparation at 902 involves ensuring that up-to-date and complete information is provided in the data submission file. An example list of fields and rules for a data submission file are set forth below as TABLE 1. In a typical data submission file submitted by an operating unit 12, there will be multiple records (representing individual transactions of operating unit) each consisting of a number of fields as set forth in TABLE 1.

TABLE 1

| Field Content | Rule(s) |
|---|---|
| Unofficial Operating Unit | Must be mapped to official |
| Name | operating unit name. |
| Unit identifier | |
| Customer Name | |
| Customer Address | A state or province code is |
| | mandatory for US/Canada. |
| | Only one address submitted |
| | per customer. |
| Customer Industry | Must be a valid 4 digit SIC |
| | code. |
| Credit Score Name | |
| Credit Score | |
| Credit Rating | |
| Deal identifier | If there is more than one |
| | transaction in the deal, the |
| | deal must have a unique |
| | identifier. |
| Deal information | |
| Transaction identifier | |
| Transaction information | Each transaction can only |
| | have one customer playing |
| | the role of obligor/investee. |
| | Each customer can have only |
| | one role in a transaction. |
| Unofficial product name | Must be mapped to official |
| | product name. |
| Maturity date | Mandatory to report a |
| | maturity date if the official |
| | product has a maturity date. |
| Transaction control code | |
| Exposure amount | An amount must be included. |
| Exposure information | Past due amounts must be |
| | reported. |
| Unit collateral name | Must be mapped to |
| | standardized collateral. |

Processing continues at 904 where each operating unit submits their submission file to, e.g., controller 200. This may be performed using any of a number of know file transfer protocols or other communications protocols including, for example, electronic mail delivery, etc.

At 906, controller 200, following instructions from program 240, performs one or more verification tests on the contents of each data submission file to ensure that the data submitted in each file is complete and follows established data quality standards. This verification testing, in one embodiment, may be broken into three stages: pre-inspection (where the file is inspected to ascertain that it is the correct version and date); inspection (where the contents of the file are checked as described below); and post-inspection (where the results of the inspection are reported and acted upon). According to one embodiment of the invention, the established data quality standards used in the inspection phase of the verification tests may be modified (e.g., to be more loosely or more stringently applied). These standards may be modified by adjusting one or more thresholds.

In one embodiment, these thresholds may be established for: (1) the number of errors encountered in a given field of each data submission file (e.g., a data submission file may “fail” verification testing if it has more than 10 errors in the industry code field); (2) the number of errors for a given field expressed as a percentage of the overall number of records (or amounts) in the data submission file; and/or (3) the presence of any “fatal” errors in the file (e.g., the lack of an exposure amount, or the failure to include a country code for the currency type may be deemed “fatal” errors because without this data exposure information may not be analyzed).

These thresholds may be variously applied to reject or accept data submission files based on the data quality requirements of business 10. For example, the thresholds may be adapted to accept a data submission file with a large number of errors if their impact on overall exposure data is negligible. For example, a file with a number of errors in the field containing customer industry codes where the total dollar amount of the records with erroneous industry codes is very small may be allowed to pass verification testing despite the errors. On the other hand, a file containing one or more records with erroneous industry codes may be rejected if the total dollar amount of those records is very large. By allowing modification of verification thresholds, embodiments of the invention allow managers and system operators to maximize data entry efficiency while ensuring that data which affects the overall exposure analysis is accurate and properly entered.

In one embodiment, thresholds may be established based on the statistical impact of errors on the overall exposure data for a particular data submission file. For example, business 10 may determine that errors in customer industry data (e.g., blank fields or improperly entered SIC codes) may be acceptable so long as the errors affect less than 30% of the overall exposure for a particular data submission file.

In one embodiment, verification testing is performed by a data verification tool which operates by reading each data submission file, record by record, parsing out the fields for each record. For each field (such as, for example, fields presenting deal information, transaction information, exposure information, etc.) of the data submission file, the contents of the field are compared against a set of user specified criteria. For example, referring to TABLE 1, above, the field “EXPOSURE AMOUNT” must have an amount in it; if the field of a received data submission file lacks data for this field, the data verification tool of the present invention records the failure and continues to parse and analyze the file for further errors. Once the file is fully parsed and analyzed, the number and type of errors are compared to pre-established thresholds to determine if the data submission file passes verification testing. Other checks may be performed on the data as well. For example, dates may be examined using date range lookup tables. Customer industry information may be examined using industry code lookup tables. Product, operating unit, collateral, and customer data may also be verified at this time to compare the data in data submission file with data mapped in the mapping processes described above in conjunction with FIG. 8 above. Other data lookups and verifications may also be performed at this time to ensure that the data contained in each data submission file is as accurate as possible.

If the data submission file fails verification testing, processing continues to 910 where defects in the file are identified and noted in a feedback file forwarded to user device 1 10. A user at operating unit 12 updates the data submission file at 912 to correct the errors identified in the feedback file, and resubmits the submission file at 904. Verification testing is again performed at 906. This process repeats until the data submission file passes verification testing. In some embodiments, a user will be allowed to override a failed verification test if, for example, the data simply cannot be corrected to otherwise pass testing.

If verification testing at 906 indicates that the data submission file is of sufficient quality (i.e., has not resulted in a “failed” verification), processing continues at 914 where the data submission file is formally submitted to controller 200 where it will become part of databases accessible by controller 200 including, for example, exposure database 600 (FIG. 6). In one embodiment, when a data submission file is formally submitted to controller 200, it is transformed into a common or universal file layout for storage in exposure database 600 and/or in other data stores accessible by controller 200.

Processing continues at 916 where the data submission file is graded to indicate the quality of the data submitted. As described above, certain errors in the data may be tolerated. Thresholds may be adjusted to permit some types of errors to pass. Grading the file provides an indication of the overall quality or confidence in the data. In one embodiment, each data submission file may receive a score of between zero and one. A score close to one indicates a data file with highly accurate data. In one embodiment, this score is arrived at using the following formula:

A=Total exposure amount affected by errors in the file

B=Total amount of exposure in the file

C=Total expected exposure amounts for rejected files

SCORE=1/(1+(A+C)/(B+C))

Those skilled in the art will recognize that other confidence measures may also be used to grade data submission files at 916. Processing continues at 918 where reports are generated and forwarded to appropriate recipients. A wide number of different reports may be used to confirm and report the successful submission of a data submission file, including confirmation reports forwarded to the operating unit which submitted the file. In one embodiment, a report is forwarded to operating unit 12 which includes a summary of the number of errors which occurred in each field of the data submission file, the percentage of total errors that each field represented, the exposure amount involved, and the percentage of the total exposure amount affected.

Process 900 is repeated for all operating units 12 of business 10. Upon completion of these processes, controller 200 will store or have access to accurate and timely exposure data from each of the operating units 12 of the business 10. Processing may now proceed to the analysis and presentation of the collected exposure data, which will be described by referring to FIG. 10.

Presentation and Analysis of Data

After data from each operating unit has been received, mapped, and verified as described above, processing continues to the presentation and analysis of data received from each of the operating units. Referring now to FIG. 10, a process 1000 for the presentation and analysis of data is shown. This process 1000 may be performed by controller 200, under control of program 240, to present exposure data in various forms to authorized managers operating management devices 120 (FIG. 1B). In one embodiment, exposure data is presented and analyzed only for certain authorized users. For example, a business may determine that exposure data is only to be presented to upper level management. This may be performed using network permissions or other data processing techniques known to those skilled in the art.

According to one embodiment of the present invention, processing begins at 1002 where one or more trigger level(s) are established. According to one embodiment of the presentation, a business (such as business 10 of FIG. 1A), may identify one or more exposure areas in which a certain threshold, or trigger level, should not be exceeded. Embodiments of the present invention permit businesses to establish a large number and variety of such levels for different types of exposures. For example, a business which takes exposures in the form of consumer debt as a result of a wide variety of consumer-oriented products (such as, for example, consumer credit cards, mortgages, insurance, auto loans, etc.) may determine that it always wants to keep it's exposure below a certain amount with respect to a particular product or geographical area. One or more trigger levels may be established at 1002 to allow managers of the business to monitor exposures of the business.

Processing continues at 1004 where one or more “screens” are generated to present information regarding various exposures of business 10 to managers operating management devices 120. These screens may be, for example, HTML-formatted pages viewable by a browser of management device 120. In one embodiment, controller 200 stores information defining a set of screens to present data in a graphical form to authorized managers so that they can have an up-to-date and accurate view of various exposures of the business. As an example for a diversified financial services business, the screens may include screens communicating: (1) the overall losses of the business; (2) consumer delinquency data; (3) information identifying non-earning assets; (4) commercial delinquency data; (5) total portfolio data including highest exposure countries; (6) total portfolio data including highest exposure speculative countries; (7) consumer data (by geographical concentration); (8) consumer data (by product); (9) information summarizing high risk segments by product and by percentage of total book; (9) single customer exposure data; (10) information identifying exposure data by industry; (11) information identifying exposure data by product mix within an industry; etc.

In one embodiment, standardized screens are generated at 1004. In other embodiments, processing at 1004 may include the generation of custom screens based on input received from, e.g., a manager operating management device 120. For example, a manager may wish to see exposure information regarding a particular product line in a particular geographical region. As another example, a manager interested in viewing the overall exposure for consumer loans in the state of California may present this custom request to system 100 via management device 120. Controller 200, upon receipt of this request, performs database queries and data manipulation to generate the requested custom screen(s) 1004. The result is a system which facilitates the tracking, monitoring, and analyzing of exposures in businesses having multiple operating units, multiple products, and multiple customers.

In some embodiments, processing may include operation of one or more analytic models or engines to generate desired data. In some embodiments, these analytic models or engines may receive input from other data sources, such as operational data from one or more operating units, or risk data from external sources. This processing may be used to generate analyses such as exposure trends, exposure segmentation data, and exposure concentration data.

Processing continues at 1006, where the screens generated at 1004 are presented to one or more managers operating management devices 120. These screens present exposure data to selected managers in a graphical format, allowing the selected managers to quickly discern, analyze and assess exposure information. Some screens may include information depicting whether or not a trigger level (established at 1002) has been exceeded or whether the exposures in a certain area are nearing the trigger level. This allows a manager operating management device 120 to take appropriate corrective action to avoid overexposure in one or more areas.

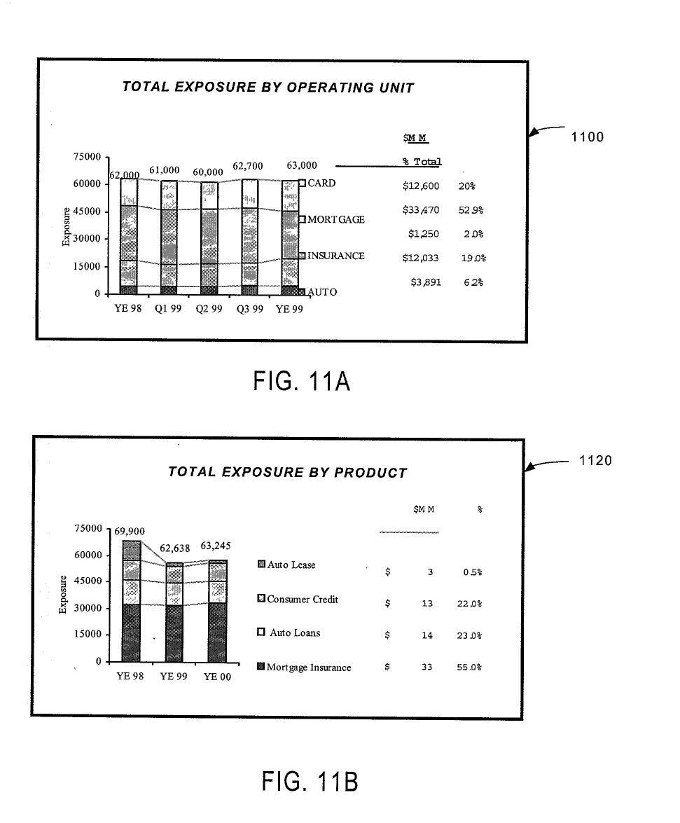

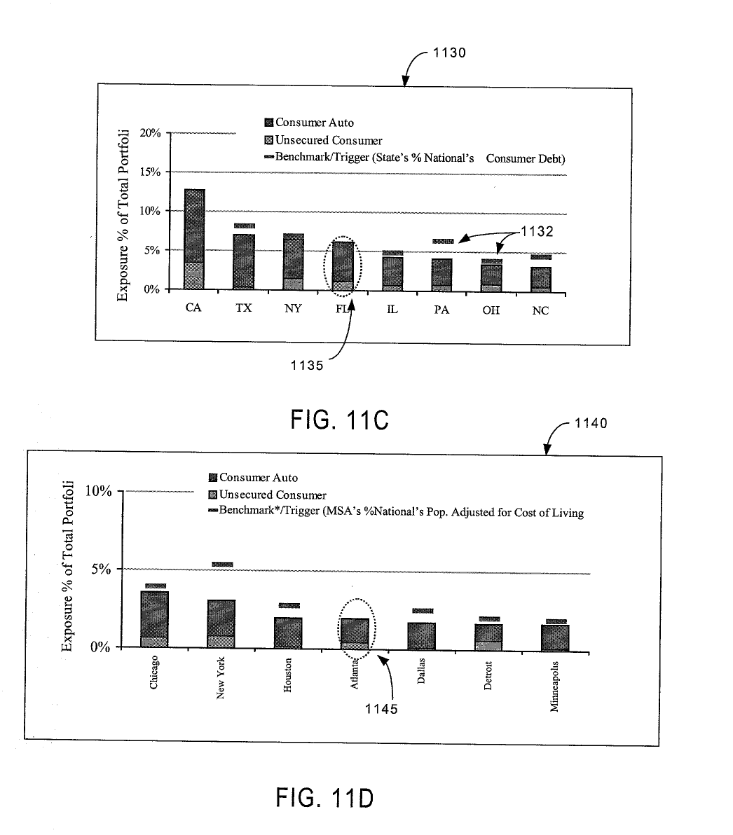

Examples of several screens which may be presented to one or more managers operating management devices 120 will now be described by referring to FIGS. 11A-D. FIG. 11A is an example screen 1100 which presents exposure data in a graphical format and in a table format for various consumer exposures of a business. FIG. 11B is a second example screen 1120 which further breaks down the consumer exposures into particular product lines of the business. FIG. 11C is a third example screen 1130 which includes a number of triggers 1132 for consumer exposures of a business in individual States of the United States. The example screen 1130 shows that the business has exceeded its trigger level in the State of Florida. An alarm indication 1135 is graphically presented on screen 1130 allowing a manager operating management device 120 to quickly discern that corrective action should be taken to avoid a potential exposure problem in the State of Florida. Screen 1130 also shows that several States are nearing the limit of desired exposure (e.g., N.Y. and Ill.), alerting managers that consumer product exposures in those States should be closely monitored.

FIG. 11D is a fourth example screen 1140 which presents consumer exposure data for a business based on metropolitan service areas (MSAs) of the United States. Trigger levels indicating a desired limit of exposure from consumer products for each of those MSAs have been established and are graphically depicted on screen 1140. An alarm indication 1145 is graphically presented on screen 1140 indicating that a trigger level has been exceeded in at least one MSA (the Atlanta MSA). This alarm indication 1145 alerts managers operating management devices 120 to take corrective action to potentially reduce consumer product exposures in that particular MSA.

Other screens and triggers may be generated by businesses utilizing embodiments of the present invention, allowing businesses to proactively monitor, evaluate, and act on exposures of the business, even where the business includes a number of different operating units, a number of different products, and a number of different customers. The result can be reduced losses for the business and improved profitability.

Although the present invention has been described with respect to a preferred embodiment thereof, those skilled in the art will note that various substitutions may be made to those embodiments described herein without departing from the spirit and scope of the present invention.

What is claimed is:

1. A method for monitoring financial exposure in an entity having a plurality of operating units, the method comprising:
gathering information about each of said operating units including at least one product identifier and at least one collateral identifier;
mapping said at least one product identifier to a standardized product identifier;
mapping said at least one collateral identifier to a standardized collateral identifier;
receiving, from each of said operating units, unit exposure data identifying an exposure of said operating unit to at least a first customer of, said operating unit based on said standardized product identifier and said standardized collateral identifier; and
generating aggregated exposure information for said entity.

2. The method of claim 1, wherein said at least one product identifier includes information identifying at least one of: a unit product name; a standardized product name; a standardized product parent; an effective date; an expiration date; and a point of contact.

3. The method of claim 1, wherein said at least one collateral identifier includes information identifying at least one of: a unit collateral name; a standardized collateral name; a standardized collateral parent; an effective date; and a point of contact.

4. The method of claim 1, wherein said at least one collateral identifier indicates that no collateral has been provided.

5. The method of claim 1, wherein said customer data includes at least one of: a customer name; a customer address; a customer industry; a credit score name; a credit score; and a credit rating.

6. The method of claim 5, further comprising:
analyzing said customer data to associate a received customer name with a legal name of said at least first customer.

7. The method of claim 6, wherein said analyzing includes:
retrieving said legal name of said at least first customer from an external data source.

8. The method of claim 4, further comprising:
analyzing said customer data to associate a received customer address with a legal name of said at least first customer.

9. The method of claim 1, wherein said unit exposure data includes at least one of: a deal identifier; a transaction identifier; information identifying a customer transaction role; a status of the transaction; a product identifier; a maturity date; information identifying a type of participation of said operating unit; an exposure amount; receivable information for said exposure amount; and a collateral identifier.

10. The method of claim 1, further comprising:
comparing said unit exposure data with at least one data standard.

11. The method of claim 10, further comprising:
rejecting said unit exposure data if said unit exposure data fails to comply with said at least one data standard.

12. The method of claim 1, further comprising:
comparing a plurality of said unit exposure data with a plurality of data standard to generate a failure number; and
accepting said unit exposure data if said failure number is less than an established threshold.

13. The method of claim 12, further comprising:
adjusting said established threshold before said comparing.

14. The method of claim 1, further comprising:
presenting said aggregated exposure information in a first format for review.

15. The method of claim 14, further comprising:
receiving a request to present said aggregated exposure information in a second format for review; and
presenting said aggregated exposure information in said second format.

16. The method of claim 1, wherein said aggregated exposure information is aggregated by at least one of: operating unit; customer; collateral; exposure amount; product; and geographical area.

17. The method of claim 1, further comprising:
establishing at least one exposure threshold amount.

18. The method of claim 17, wherein said at least one exposure threshold amount is established for at least one of: a product; a collateral; a customer; an operating unit; a geographical area; a group of products; and a group of operating units.

19. The method of claim 17, further comprising:
presenting said aggregated exposure information in a first format for review; and
indicating said at least one exposure threshold amount in said first format.

20. The method of claim 1, further comprising:
receiving a request to present said aggregated exposure information in a first format for review;
performing at least one data analysis on said aggregated exposure information; and
presenting said aggregated exposure information in said first format for review.

21. A device for monitoring financial exposure in an entity having a plurality of operating units, comprising:
a processor;
a communication device, coupled to said processor, receiving product information, collateral information, customer information and unit exposure information from said plurality of operating units, said unit exposure information identifying an exposure of each of said operating units to one or more customers;
a storage device in communication with said processor and storing instructions adapted to be executed by said processor to:
generate aggregated exposure data for said entity based on said information received from each of said operating units.

22. A computer program product in a computer readable medium for monitoring financial exposure in an entity having a plurality of operating units, comprising:
first instructions for gathering information about each of said operating units including at least one product identifier and at least one collateral identifier;
second instructions for mapping said at least one product identifier to a standardized product identifier;
third instructions for mapping said at least one collateral identifier to a standardized collateral identifier;
fourth instructions for receiving, from each of said operating units, unit exposure data identifying an exposure of said operating unit to at least a first customer of said operating unit based on said standardized product identifier and said standardized collateral identifier; and
fifth instructions for generating aggregated exposure information for said entity.

23. A method for generating standardized financial exposure data, comprising:
periodically receiving, from each of a plurality of operating units of a business, information identifying a plurality of products and a plurality of collateral of each of said operating units;
mapping said information identifying said plurality of products and said plurality of collateral to standardized product and standardized collateral names;
periodically receiving, from each of a plurality of operating units of a business, exposure data including customer data identifying at least a first customer of each of said operating units, and unit exposure data identifying an exposure of each of said operating units to said at least first customer of said operating unit;
associating said exposure data with said standardized product and standardized collateral names;
comparing said exposure data to data standards to determine if said exposure data is acceptable; and
storing said exposure data if said comparing indicates that said exposure data is acceptable.

24. A method for submitting financial exposure data from an operating unit of an entity having a plurality of operating units, comprising:
generating, at said operating unit, information about said operating unit including at least one product and at least one collateral item;
mapping said at least one product to a standardized product identifier;
mapping said at least one collateral item to a standardized collateral identifier;
periodically generating unit exposure data for said operating unit, said unit exposure data identifying financial exposures of said operating unit to at least a first customer based on at least one standardized product identifier and at least one standardized collateral identifier;
submitting said unit exposure data for approval; and
receiving an approval of said unit exposure data if said unit exposure data satisfies at least one data quality standard.
